(19) United States
(12) Patent Application Publication
(10) Pub. No.: US 2025/0010683 A1
(43) Pub. Date: Jan. 9, 2025

(54) IN-VEHICLE AIR CONDITIONING OUTLET STATE INDICATOR AND VEHICLE

(71) Applicant: HONDA MOTOR CO., LTD., Tokyo (JP)

(72) Inventor: Qin Huang, Beijing (CN)

(21) Appl. No.: 18/762,705

(22) Filed: Jul. 3, 2024

(30) Foreign Application Priority Data
Jul. 7, 2023 (CN) 2023108354060

(51) Int. Cl. B60H 1/00

(52) U.S. Cl. CPC B60H 1/00028; B60H 2001/00092; B60H 2001/00192

(57) ABSTRACT

The present invention relates to an in-vehicle air conditioning outlet state indicator and a vehicle, including: an air conditioning outlet of which an air outlet direction is changeable; and an interior trim panel provided with an indication unit displaying, in a working state, an indication mark used for indicating a current air outlet direction of the air conditioning outlet, in which when the air outlet direction of the air conditioning outlet changes, the indication unit also changes, or when the indication mark changes, the air outlet direction of the air conditioning outlet also changes.

### CROSS-REFERENCE TO RELATED APPLICATION

Priority is claimed on Chinese Patent Application No. 2023108354060, filed on Jul. 7, 2023, the contents of which are incorporated herein by reference.

### BACKGROUND OF THE INVENTION

### Field of the Invention

This application relates to the technical field of vehicles, in particular to an in-vehicle air conditioning outlet state indicator and a vehicle.

### Description of Related Art

When using a vehicle, a user needs to use an air conditioner to adjust a temperature in a compartment thereof, thereby improving the driving comfort and the riding comfort. In the past, a direction, an air volume, and a temperature of an air conditioning outlet in the vehicle compartment have to be manually adjusted, and current state parameters after the adjustment are not displayed, the direction, the air volume, and the temperature can only be distinguished by sensory perception of the user, but these perceptions are not explicit. With the development of technology, the direction, the air volume, and the temperature of the air outlet can be adjusted and controlled through a vehicle machine screen, and parameters of the current air outlet can be displayed on the vehicle machine screen. When the user needs to know the current state parameter of the air outlet, the user or a driver must divert the sight to an interface of the vehicle machine screen for viewing. When air conditioner information is to be displayed on the vehicle machine screen, air outlet state information of the plurality of air conditioning outlets is all displayed in the interface, so that an area occupied by air outlet state information of a single air conditioning outlet in the interface is small, and it requires the user to divert the sight for multiple times for viewing to confirm all state parameters of the air outlet, which not only degrades the user experience, but also degrades the driving safety.

Therefore, with an increasing number of functions in a vehicle, in order to improve the driving safety and enhance the user experience, how to reduce the number of times for a user to view an interface of a vehicle machine screen and intuitively and quickly acquire air conditioner information related to an air outlet while ensuring the driving safety is a subject to be studied.

### SUMMARY OF THE INVENTION

In view of the above problems in the prior art, this application provides an in-vehicle air conditioning outlet state indicator and a vehicle, which can improve the user experience.

A first aspect of this application provides an in-vehicle air conditioning outlet state indicator, including: an air conditioning outlet of which an air outlet direction is changeable; and an interior trim panel provided with an indication unit displaying, in a working state, an indication mark used for indicating a current air outlet direction of the air conditioning outlet, in which when the air outlet direction of the air conditioning outlet changes, the indication mark also changes, or when the indication mark changes, the air outlet direction of the air conditioning outlet also changes.

As described above, by providing the indication unit in the interior trim panel, indicating the air outlet direction of the air conditioning outlet by the indication mark displayed by the indication unit, and the indication mark correspondingly changing according to a real-time change of the air outlet direction and always indicates the real-time air outlet direction, when the air outlet direction changes, the indication mark is led to change correspondingly, meanwhile, there may be another case in which a display state of the indication mark is adjusted to lead the air outlet direction to change. In either case, the indication mark corresponds to the real-time air outlet direction, so that air outlet direction information of the air conditioning outlet can be displayed outside the vehicle machine screen, thereby avoiding an annoyance to a user due to other information on the vehicle machine screen. The user can directly acquire the air outlet direction information of the air conditioning outlet according to the indication unit, without distinguishing among a large amount of information. Accordingly, it is possible for the user to conveniently acquire state parameters of the air conditioning outlet, the user experience is improved, the number of times of sight diversion when the user views the parameters can be reduced, and the driving safety thereof is improved.

In a possible implementation of the first aspect, the indication mark includes at least one first mark extending in a vehicle-height direction or a vehicle-width direction, and an inclination direction of the first mark relative to the vehicle-height direction or the vehicle-width direction indicates the air outlet direction of the air conditioning outlet.

As described above, by indicating the air outlet direction of the air conditioning outlet by an inclination direction of the first mark, the air outlet direction information of the air conditioning outlet can be displayed to the user more intuitively, thereby allowing the user to conveniently confirm the air outlet direction of the air conditioning outlet, reducing the number of times of sight diversion during parameter viewing, improving the driving safety, and improving the user experience.

In a possible implementation of the first aspect, the indication mark includes the at least one first mark extending in the vehicle-height direction, and an inclination direction of the first mark extending in the vehicle-height direction relative to the vehicle-width direction indicates a left-right air outlet direction of the air conditioning outlet.

As described above, the user can confirm the left-right air outlet direction of the air conditioning outlet according to a left-right inclination direction of the first mark, thereby allowing the user to conveniently confirm the left-right air outlet direction of the air conditioning outlet, and improving the user experience.

In a possible implementation of the first aspect, the indication mark includes the at least one first mark extending in the vehicle-width direction, and an inclination direction of the first mark extending in the vehicle-width direction relative to the vehicle-height direction indicates an up-down air outlet direction of the air conditioning outlet.

As described above, the user can confirm the up-down air outlet direction of the air conditioning outlet according to an up-down inclination direction of the first mark, thereby allowing the user to conveniently confirm the up-down air outlet direction of the air conditioning outlet, and improving the user experience.

In a possible implementation of the first aspect, the indication mark further includes a second mark arranged on the first mark, and a position where the second mark is present on the first mark in the vehicle-height direction is used to indicate an up-down air outlet direction of the air conditioning outlet.

As described above, by arranging the second mark on the first mark, the user is allowed to confirm up-down air outlet information of the air conditioning outlet according to a height of the second mark on the first mark while acquiring left-right air outlet information of the air conditioning outlet through the first mark. Accordingly, the number of pieces of air outlet state information acquired by the user at the same time can be increased, the number of times of head lowering during parameter viewing can be reduced, the driving safety is improved, and the user experience can be improved.

In a possible implementation of the first aspect, a size of the first mark is used to indicate an air outlet volume of the air conditioning outlet.

As described above, the user can more intuitively acquire air outlet volume information of the air conditioning outlet through the size of the first mark, and in addition, the air outlet volume information can be displayed through the first mark while the air outlet direction is displayed through the first mark. Accordingly, the number of pieces of the air outlet state information acquired by the user at the same time can be increased, the number of times of head lowering during parameter viewing can be reduced, the driving safety can be improved, and the user experience can be improved.

In a possible implementation of the first aspect, the size of the first mark includes at least one of an area, a length, and a width of the first mark.

As described above, the user can confirm the air outlet volume of the air outlet according to the area, the length, and the width of the first mark, which is very intuitive and the user can accurately acquire information on the air outlet volume without too much thinking.

In a possible implementation of the first aspect, the indication mark includes at least one third mark with a gradually changing width, and a direction in which the width of the third mark gradually changes is used to indicate the air outlet direction of the air conditioning outlet.

As described above, by indicating the air outlet direction of the air conditioning outlet by a direction in which the width of the third mark gradually changes, the air outlet direction information of the air conditioning outlet can be displayed to the user more intuitively, thereby allowing the user to conveniently confirm the air outlet direction of the air conditioning outlet, reducing the number of times of head lowering during parameter viewing, improving the driving safety, and improving the user experience.

In a possible implementation of the first aspect, the third mark gradually changes in width in a vehicle-height direction, and a direction in which the width of the third mark decreases or increases indicates an up-down air outlet direction of the air conditioning outlet.

As described above, the width of the third mark gradually decreases in the vehicle-height direction, thereby forming an arrow shape toward an up-down direction. Alternatively, the width of the third mark gradually increases in the vehicle-height direction, thereby forming a horn shape toward the up-down direction. Accordingly, it is possible for the user to conveniently confirm the up-down air outlet direction of the air conditioning outlet.

In a possible implementation of the first aspect, an inclination direction of the third mark relative to a vehicle-width direction indicates a left-right air outlet direction of the air conditioning outlet.

As described above, the left-right air outlet direction of the air outlet can be indicated by the inclination direction of the third mark while the up-down air outlet direction of the air outlet is indicated by the third mark. Accordingly, the air outlet direction information of the air outlet displayed by the third mark can be increased, thereby allowing the user to conveniently confirm the air outlet direction of the air conditioning outlet, reducing the number of times of head lowering during parameter viewing, improving the driving safety, and improving the user experience.

In a possible implementation of the first aspect, the third mark gradually changes in width in a vehicle-width direction, and a direction in which the width of the third mark decreases or increases indicates a left-right air outlet direction of the air conditioning outlet.

As described above, the width of the third mark gradually changes in the vehicle-width direction, thereby forming an arrow shape toward a left-right direction. Alternatively, the width of the third mark gradually increases in the vehicle-width direction, thereby forming a horn shape toward the up-down direction. Accordingly, it is possible for the user to conveniently confirm the left-right air outlet direction of the air conditioning outlet.

In a possible implementation of the first aspect, an inclination direction of the third mark relative to a vehicle-height direction indicates an up-down air outlet direction of the air conditioning outlet.

As described above, the up-down air outlet direction of the air outlet can be indicated by the inclination direction of the third mark while the left-right air outlet direction of the air outlet is indicated by the third mark. Accordingly, the air outlet direction information of the air outlet displayed by the third mark can be increased, thereby allowing the user to conveniently confirm the air outlet direction of the air conditioning outlet, reducing the number of times of head lowering during parameter viewing, improving the driving safety, and improving the user experience.

In a possible implementation of the first aspect, the indication mark includes at least one fourth mark for flow display, swing display, or rotation display, and a direction of the flow display, the swing display, or the rotation display of the fourth mark is used to indicate the air outlet direction of the air conditioning outlet.

As described above, the indication mark dynamically indicates the air outlet direction of the air conditioning outlet through the fourth mark for flow display, swing display, or rotation display, thereby allowing the user to conveniently confirm the air outlet direction of the air conditioning outlet, and improving the user experience.

In a possible implementation of the first aspect, the indication mark includes at least two types of marks, and a combination of the at least two types of marks can be used to indicate at least a left-right air outlet direction and an up-down air outlet direction of the air conditioning outlet.

As described above, a combination of any two or more indication marks can be used to indicate the air outlet direction of the air conditioning outlet in a more diversified manner, meanwhile, one of any two indication marks can be used to indicate the left-right air outlet direction, and the other of the any two indication marks can be used to indicate the up-down air outlet direction. With such an arrangement, the air outlet direction is displayed more perfectly and the display is more interesting. Meanwhile, it is possible for the user to confirm the air outlet direction of the air conditioning outlet more conveniently, the number of times of head lowering during parameter viewing can be reduced, the driving safety can be improved, and the user experience can be improved.

In a possible implementation of the first aspect, a color of the indication mark is used to indicate an air outlet temperature of the air conditioning outlet.

As described above, the user can determine the air outlet temperature of the air conditioning outlet by the color of the indication mark, so that the air outlet temperature information of the air conditioning outlet can be displayed to the user more intuitively, thereby allowing the user to conveniently confirm the air outlet temperature of the air conditioning outlet. Further, a type of the state information of the air conditioning outlet included in the indication mark can be increased, the number of times of head lowering during parameter viewing can be reduced, the driving safety can be improved, and the user experience can be improved.

In a possible implementation of the first aspect, the indication mark is located at a position around the air conditioning outlet.

As described above, the indication mark is provided at the position around the air conditioning outlet, so that it is possible for the user to conveniently confirm state information of a corresponding air conditioning outlet, thereby improving the user experience.

In a possible implementation of the first aspect, the air conditioning outlet is provided with a sensor for detecting at least one of the air outlet direction, an air outlet temperature, and an air outlet volume.

As described above, the air outlet direction, the air outlet temperature, and the air outlet volume of the air conditioning outlet can be detected in real time, and the detected data is fed back to a controller, so that a change of the indication mark is adjusted based on real-time data, thereby improving the accuracy of the air outlet information of the air conditioning outlet.

In a possible implementation of the first aspect, the indication unit is activated to enter the working state based on a detection result of the sensor.

As described above, the indication unit can display the air outlet information of the air conditioning outlet in time, thereby improving the user experience.

In a possible implementation of the first aspect, the indication unit is activated to enter the working state when the air conditioning outlet is in an open state.

As described above, the indication unit can display the air outlet information of the air conditioning outlet in time, thereby improving the user experience.

In a possible implementation of the first aspect, the indication unit includes a sleep state in which the indication mark is not displayed, and the indication unit enters the sleep state after maintaining the working state for a predetermined period of time.

As described above, the indication unit enters the sleep state after maintaining the working state for the predetermined period of time, so that energy consumption of the indication unit can be reduced, thereby saving electric energy.

In a possible implementation of the first aspect, the indication unit can be switched from the sleep state to the working state by any means of voice, button, touch, gesture, and sight.

As described above, when the user needs to know the state information of the air conditioning outlet, the indication unit may enter the working state by means of voice, button, touch, gesture, sight, and the like, thereby displaying the indication mark to display the state information of the air conditioning outlet. Accordingly, it is possible for the user to use, and the user experience is improved.

In a possible implementation of the first aspect, the interior trim panel is provided with an ambient light, and the indication unit includes at least a part of the ambient light.

As described above, the indication unit and the ambient light can be combined together, thereby improving the user experience.

In a possible implementation of the first aspect, the interior trim panel is provided with an ambient light of which a display mode is linked with the indication mark.

As described above, the ambient light is linked with the indication mark, so that light patterns on the interior trim panel can be more coordinated and flexible, thereby improving the aesthetics of the interior trim panel, and improving the user experience.

In a possible implementation of the first aspect, the indication mark is a light-emitting pattern that changes statically or dynamically.

As described above, by using the light-emitting pattern that changes statically or dynamically as the indication mark, the indication mark is more plentiful, the light-emitting pattern is more intuitive, and a user can conveniently acquire information, thereby improving the user experience.

In a possible implementation of the first aspect, the air outlet direction of the air conditioning outlet at least includes a left-right air outlet direction and an up-down air outlet direction, and the indication mark is used to indicate at least one of the air outlet directions.

As described above, various air outlet directions of the air conditioning outlet can all be displayed by the indication mark, a user can acquire any information desired to be acquired by the indication mark, which is more comprehensive, and the most important air outlet information on the up-down direction and left-right direction can be acquired in time for the user, and the directions can be adjusted in time based on actual requirements.

In a possible implementation of the first aspect, the indication mark can be set by a user selection or a customized setting.

As described above, the indication mark is not fixed, and may include various types of modes or styles, which are selected and set by the user based on his/her own preferences or habits, so as to better meet the requirements of the user. Certainly, the user may also make a customized design, and use a solution designed by the user as an indication mark, thereby meeting a personalized use requirement of the user to the greatest extent.

In a possible implementation of the first aspect, a change of the air outlet direction of the air conditioning outlet includes any of the following: a change of the air outlet direction of the air conditioning outlet caused by the user manually adjusting the air outlet direction of the air conditioning outlet; a change of the air outlet direction of the air conditioning outlet caused by an automatic adjustment of the air conditioning outlet; and an adjustment of the air outlet direction of the air conditioning outlet caused by the user adjusting a display state of the indication mark.

As described above, the change of the air outlet direction of the air conditioning outlet may include various situations, such as a manual adjustment, an automatic adjustment, or an adjustment of the air outlet direction by adjusting the indication mark. In any case, as long as there is an air outlet direction or there is a change in the air outlet direction, it can be displayed by the indication mark, which is an intuitive and convenient information acquisition manner for the user.

In a possible implementation of the first aspect, one indication unit is able to be used to indicate current air outlet directions of at least two air conditioning outlets.

As described above, even when there are more air conditioning outlets, air outlet states thereof can be displayed by using as few indication units as possible, thereby reducing the number of the indication units, which has an advantage in cost.

A second aspect of this application provides a vehicle including: at least one seat; and the in-vehicle air conditioning outlet state indicator according to any one in the first aspect of this application, in which the seat is provided corresponding to at least one air conditioning outlet and at least one indication unit.

As described above, by providing the indication unit on the interior trim panel, and indicating the air outlet direction of the air conditioning outlet by the indication mark displayed by the indication unit, the display of the air outlet direction information of the air conditioning outlet can be separated from the vehicle machine screen, and an annoyance to the user due to other information on the vehicle machine screen is avoided. The user can directly acquire the air outlet direction information of the air conditioning outlet according to the indication mark, without distinguishing among a large amount of information. Accordingly, it is possible for the user to conveniently acquire the state parameter of the air conditioning outlet, the number of times of head lowering during parameter viewing can be reduced, the driving safety can be improved, and the user experience can be improved.

In a possible implementation of the second aspect, the air conditioning outlet corresponding to the seat is in an open state, and when a user sits on the seat, the indication unit corresponding to the seat enters the working state.

As described above, the indication unit is in the open state at the air conditioning outlet, and enters the working state when a user sits on the corresponding seat, so that energy consumption of the indication unit can be reduced, thereby saving electric energy. Meanwhile, the indication unit enters the working state after the user sits on the seat, so that it is possible for the user to conveniently know the state information of the air conditioning outlet, thereby improving the user experience.

In a possible implementation of the second aspect, the indication unit corresponding to the air conditioning outlet enters the working state when the indication unit is in a sleep state and a user adjusts a state of the air conditioning outlet,
or the indication unit enters the working state when the indication unit is in the sleep state and approaching of a user is sensed.

As described above, when the user adjusts the air conditioning outlet, the user can conveniently know a state of the air conditioning outlet after the adjustment, thereby facilitating operations of the user. Meanwhile, the indication unit can enter the working state when approaching of a user is sensed, which is convenient for the user to view.

In a possible implementation of the second aspect, the indication unit is located within an observable range of a user sitting on the seat when the user looks straight ahead.

As described above, by providing the indication unit within the range observable in the sight of the front view of the user, a driving risk caused by the user lowering head or diverting sight to view the state information of the air conditioning outlet can be avoided. Accordingly, the driving safety can be improved, and the user experience can be improved.

In a possible implementation of the second aspect, the vehicle includes a driver seat, a passenger seat, and a rear seat, and the indication unit corresponding to the driver seat is located on an instrument panel on a side of the vehicle close to the driver seat, or, the indication unit corresponding to the passenger seat is located on an instrument panel on a side of the vehicle close to the passenger seat or located at an inner side of a vehicle door on the side of the passenger seat, or, the indication unit corresponding to the rear seat is located at a back portion of the driver seat or the passenger seat, or located at an inner side of a vehicle door closest to the rear seat or at a rear end of a front central console armrest.

As described above, users sitting on the driver seat, the passenger seat, and the rear seat can acquire the air outlet information of the air conditioning outlet more conveniently, so that the user experience can be improved.

In a possible implementation of the second aspect, the vehicle includes a plurality of interior trim panels corresponding to a plurality of the seats, and a plurality of the indication units corresponding to the plurality of the seats in the vehicle are arranged on the same interior trim panel, or the plurality of the indication units corresponding to the plurality of the seats in the vehicle are respectively arranged on different interior trim panels, or at least two indication units among the plurality of the indication units corresponding to the plurality of seats in the vehicle are arranged on the same interior trim panel.

As described above, the plurality of indication units corresponding to the plurality of air outlets may be located on different interior trim panels, respectively, to allow each user to conveniently view the information, respectively, and two or more indication units may also be provided on the same interior trim panel, to allow one user to integrally grasp states of more indication units, and selections can be made based on different user requirements.

In a possible implementation of the second aspect, the vehicle includes a plurality of the interior trim panels corresponding to the plurality of the seats, and a user is able to set at least one of the indication units to any of the plurality of the interior trim panels by himself/herself.

As described above, a position of the indication unit may be set based on actual requirements of the user, thereby meeting different requirements of different users, which is more friendly to the user.

These and other aspects of the present invention will be more apparent in the following description of embodiment(s).

### BRIEF DESCRIPTION OF THE DRAWINGS

Hereinafter, various features of the present invention and relations between the various features are further described with reference to the drawings. The drawings are all exemplary, some features are not shown to scale, and features that are conventional and unnecessary to this application in the field related to in this application may be omitted in some drawings, or the features that are unnecessary to this application are additionally shown, and a combination of the features shown in the drawings is not used to limit this application. In addition, throughout the description, the same reference numerals refer to the same content. Specific descriptions of the drawings are as follows:

FIG. 1 is a schematic structural diagram of an in-vehicle air conditioning outlet state indicator according to a first embodiment of this application;

FIG. 2 is a schematic structural diagram of an in-vehicle air conditioning outlet state indicator according to a second embodiment of this application;

FIGS. 3A and 3B are schematic diagrams of changes in display state of an indication mark in FIG. 2;

FIG. 4 is a schematic structural diagram of an in-vehicle air conditioning outlet state indicator according to a third embodiment of this application;

FIG. 5 is a schematic structural diagram of an in-vehicle air conditioning outlet state indicator according to a fourth embodiment of this application;

FIGS. 6A, 6B, and 6C are schematic diagrams of changes of a first mark in FIG. 1 when an air outlet volume decreases;

FIG. 7 is a schematic structural diagram of an in-vehicle air conditioning outlet state indicator according to a fifth embodiment of this application;

FIG. 8 is a schematic structural diagram of a vehicle according to an embodiment of this application; and

FIG. 9 is a schematic structural diagram of a driver visual angle of the vehicle in FIG. 8.

### REFERENCE SIGNS LIST

1: vehicle
10: in-vehicle air conditioning outlet state indicator
100: air conditioning outlet
200: interior trim panel
210: indication unit
220: indication mark
221: first mark
222: second mark
223: third mark
20: seat
21: driver seat
22: passenger seat
30: instrument panel
40: instrument screen
50: vehicle machine screen
60: ambient light
70: door panel

### DETAILED DESCRIPTION OF THE INVENTION

Similar terms such as “first, second, third, and the like” in the description and claims are only used to distinguish similar objects, and do not represent a specific order for the objects, and it may be understood that the specific order or sequential orders may be interchanged when allowed, so that the embodiments of this application described herein can be implemented in an order other than that shown or described herein.

The term “include/comprise” as used in the description and claims should not be construed as limited to what is listed thereafter, and it does not exclude other elements. Therefore, the term should be interpreted as specifying the presence of the mentioned features, integers, or components, but does not preclude the presence or addition of one or more other features, integers, or components and a group thereof. Thus, the expression “an apparatus including devices A and B” should not be limited to an apparatus consisting only of components A and B.

“One embodiment” or “embodiments” referred to in the description means that a specific feature, structure, or characteristic described in combination with the embodiment is included in at least one embodiment of the present invention. Therefore, the term “in one embodiment” or “in the embodiments” appearing throughout the description do not necessarily all refer to the same embodiment, but may refer to the same embodiment. Further, in one or more embodiments, respective specific features, structures, or characteristics can be combined in any suitable manner, as will be apparent to those having ordinary skills in the art from this disclosure.

Hereinafter, a specific structure of an in-vehicle air conditioning outlet state indicator 10 in an embodiment of this application will be described in detail with reference to the drawings.

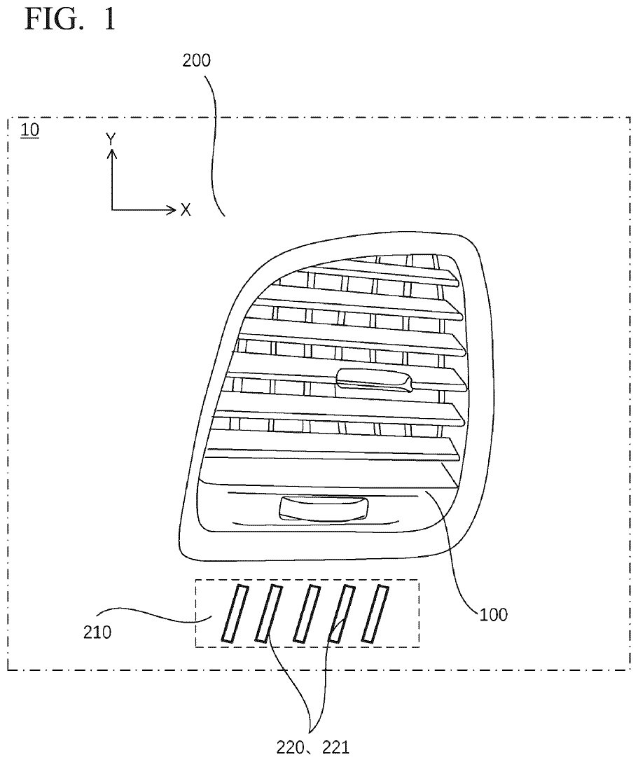

FIG. 1 is a schematic structural diagram of the in-vehicle air conditioning outlet state indicator 10 according to a first embodiment of this application. As shown in FIG. 1, the in-vehicle air conditioning outlet state indicator 10 of this application includes an air conditioning outlet 100 and an interior trim panel 200. An air outlet direction of the air conditioning outlet 100 is changeable, specifically, the air outlet direction may be manually or automatically or electrically adjusted in, for example, a vehicle-width direction X (that is, left-right direction) and a vehicle-height direction Y (that is, up-down direction), for example, the air outlet direction may be adjusted by manual operation or voice on an in-vehicle display screen. The interior trim panel 200 is provided with an indication unit 210 displaying, in a working state, an indication mark 220 used for indicating a current air outlet direction of the air conditioning outlet 100, in which when the air outlet direction of the air conditioning outlet 100 changes, the indication mark 220 also changes, or when the indication mark 220 changes, the air outlet direction of the air conditioning outlet 100 also changes.

As described above, by providing the indication unit 210 on the interior trim panel 200, indicating the air outlet direction of the air conditioning outlet 100 by the indication mark 220 displayed by the indication unit 210, and the indication mark 220 correspondingly changing according to a real-time change of the air outlet direction and always indicates the real-time air outlet direction, when the air outlet direction changes, the indication mark 220 is led to change correspondingly, meanwhile, there may be another case in which the indication unit 210 may have an adjustment function and a display state of the indication mark 220 is adjusted to lead the air outlet direction to change. In either case, the indication mark 220 corresponds to the real-time air outlet direction, so that air outlet direction information of the air conditioning outlet 100 can be displayed outside the vehicle machine screen, thereby avoiding an annoyance to a user due to other information on the vehicle machine screen. One air conditioning outlet 100 may correspond to one or more indication units 210, or one indication unit 210 may correspond to one or more air conditioning outlets 100, which is not limited herein, and settings may be made based on actual conditions. The user can directly acquire the air outlet direction information of the air conditioning outlet 100 according to the indication unit 210, without distinguishing among a large amount of information. Accordingly, it is possible for the user to conveniently acquire state parameters of the air conditioning outlet 100, the user experience is improved, the number of times of sight diversion when the user views the parameters can be reduced, and the driving safety thereof is improved.

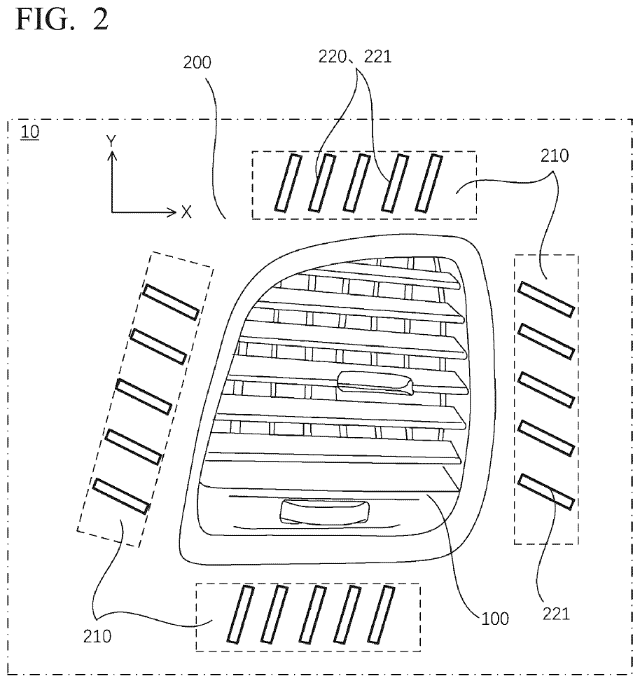

FIG. 2 is a schematic structural diagram of an in-vehicle air conditioning outlet state indicator 10 according to a second embodiment of this application. As shown in FIG. 1 and FIG. 2, the indication mark 220 includes at least one first mark 221 extending in the vehicle-height direction Y or the vehicle-width direction X, and an inclination direction of the first mark 221 relative to the vehicle-height direction Y or the vehicle-width direction X indicates an air outlet direction of the air conditioning outlet 100. As described above, the air outlet direction of the air conditioning outlet 100 is indicated by the inclination direction of the first mark 221, so that the air outlet direction information of the air conditioning outlet 100 can be displayed to the user more intuitively, thereby allowing the user to conveniently confirm the air outlet direction of the air conditioning outlet 100, reducing the number of times of head lowering during parameter viewing, improving the driving safety, and improving the user experience.

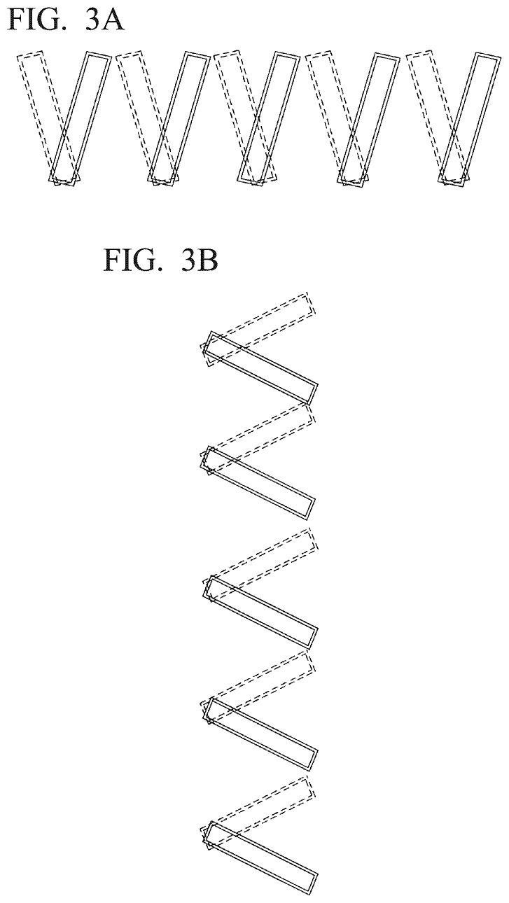

FIGS. 3A and 3B are schematic diagrams of changes in display state of the indication mark 220 in FIG. 2, in which FIG. 3A shows a change of the indication marks 220 at positions above and below the air conditioning outlet 100 in FIG. 2 before (solid line portion) and after (dotted line portion) an adjustment of the air outlet direction of the air conditioning outlet 100. FIG. 3B shows a change of the indication marks 220 at positions on the left and right of the air conditioning outlet 100 in FIG. 2 before (solid line portion) and after (dotted line portion) an adjustment of the air outlet direction of the air conditioning outlet 100.

As shown in FIGS. 1, 2, 3A and 3B, the indication mark 220 includes at least one first mark 221 extending in the vehicle-height direction Y, and an inclination direction of the first mark 221 extending in the vehicle-height direction Y relative to the vehicle-width direction X indicates a left-right air outlet direction of the air conditioning outlet 100. Specifically, the first mark 221 may be one or more arranged above and/or below the air conditioning outlet 100, for example, a plurality of first marks 221 arranged above and below the air conditioning outlet 100 and arranged along the left-right direction as shown in FIG. 2. When an air direction of the air conditioning outlet 100 shifts to the right, the first marks 221 located above and below the air conditioning outlet 100 will rotate correspondingly, and upper ends of the first marks 221 located above and below the air conditioning outlet 100 will incline to the right to indicate that the air direction of the air conditioning outlet 100 shifts to the right. When the air direction of the air conditioning outlet 100 changes and is adjusted to shift to the left, the first marks 221 located above and below the air conditioning outlet 100 will rotate correspondingly, and the upper ends of the first marks 221 located above and below the air conditioning outlet 100 will incline to the left to indicate that the air direction of the air conditioning outlet 100 shifts to the left. Alternatively, in some embodiments, the upper end of the first mark 221 located above the air conditioning outlet 100 may incline to left and right, and a lower end of the first mark 221 located below the air conditioning outlet 100 may incline to left and right, that is, a shift direction of the air direction of the air conditioning outlet 100 is indicated by an inclination direction of one end of the first mark 221 away from the air conditioning outlet 100. As described above, the user can confirm the left-right air outlet direction of the air conditioning outlet 100 according to a left-right inclination direction of the first mark 221, thereby allowing the user to conveniently confirm the left-right air outlet direction of the air conditioning outlet 100, and improving the user experience.

As shown in FIGS. 2, 3A and 3B, the indication mark 220 includes at least one first mark 221 extending in the vehicle-width direction X, and an inclination direction of the first mark 221 extending in the vehicle-width direction X relative to the vehicle-height direction Y indicates an up-down air outlet direction of the air conditioning outlet 100. Specifically, the first mark 221 may be one or more arranged on a left side and/or a right side of the air conditioning outlet 100, for example, a plurality of first marks 221 arranged on the left side and the right side of the air conditioning outlet 100 and arranged along the up-down direction as shown in FIG. 2. When the air direction of the air conditioning outlet 100 shifts downward, the first marks 221 located on the left side and the right side of the air conditioning outlet 100 will rotate correspondingly, and right ends of the first marks 221 located on the left side and the right side of the air conditioning outlet 100 will incline downward to indicate that the air direction of the air conditioning outlet 100 shifts downward. When the air direction of the air conditioning outlet 100 changes and is adjusted to shift upward, the first marks 221 located on the left side and the right side of the air conditioning outlet 100 will rotate correspondingly, and right ends of the first marks 221 located on the left side and the right side of the air conditioning outlet 100 will incline upward to indicate that the air direction of the air conditioning outlet 100 shifts upward. Alternatively, in some embodiments, a left end of the first mark 221 located on the left side of the air conditioning outlet 100 may incline up and down, and the right end of the first mark 221 located on the right side of the air conditioning outlet 100 may incline up and down, that is, the shift direction of the air direction of the air conditioning outlet 100 is indicated by an inclination direction of one end of the first mark 221 away from the air conditioning outlet 100. As described above, the user can confirm the up-down air outlet direction of the air conditioning outlet 100 according to an up-down inclination direction of the first mark 221, thereby allowing the user to conveniently confirm the up-down air outlet direction of the air conditioning outlet 100, and improving the user experience.

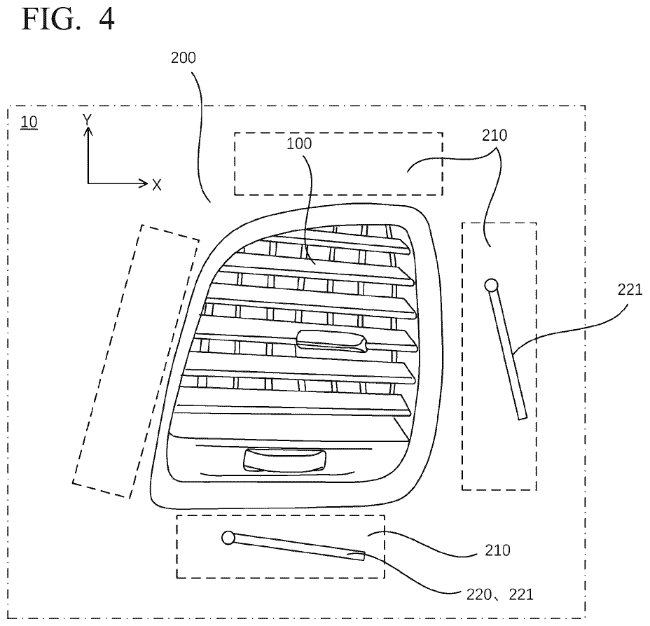

FIG. 4 is a schematic structural diagram of an in-vehicle air conditioning outlet state indicator 10 according to a third embodiment of this application. As shown in FIG. 4, in some embodiments, the indication mark 220 includes one first mark 221 arranged on the right side of the air conditioning outlet 100 and one first mark 221 arranged below the air conditioning outlet 100. The first mark 221 arranged on the right side of the air conditioning outlet 100 extends along the up-down direction, and may swing left and right with an upper end thereof as the center, and the user may determine the left-right air outlet direction of the air conditioning outlet 100 according to a left-right inclination direction of a lower end of the first mark 221. The first mark 221 arranged below the air conditioning outlet 100 extends along the left-right direction, and may swing up and down with a left end thereof as the center, and the user may determine the up-down air outlet direction of the air conditioning outlet 100 according to an up-down inclination direction of a right end of the first mark 221.

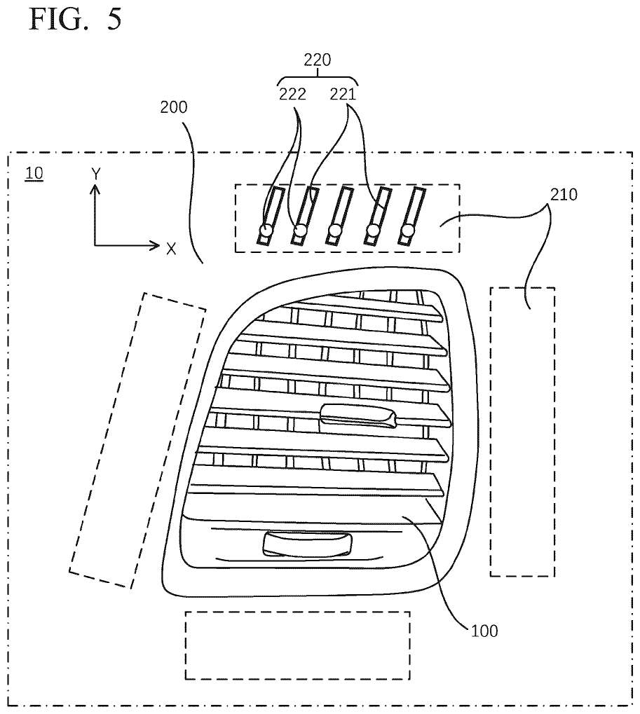

FIG. 5 is a schematic structural diagram of an in-vehicle air conditioning outlet state indicator 10 according to a fourth embodiment of this application. As shown in FIG. 5, in some embodiments, the indication mark 220 further includes a second mark 222, the second mark 222 is arranged on the first mark 221, and a position where the second mark 222 is present on the first mark 221 in the vehicle-height direction Y is used to indicate the up-down air outlet direction of the air conditioning outlet 100. When the up-down air outlet direction changes, the position where the second mark 222 is present on the first mark 221 also changes. For example, when the air outlet direction is adjusted upward, the second mark 222 will move upward relative to a current position. As described above, by providing the second mark 222 on the first mark 221, the user is allowed to confirm up-down air outlet information of the air conditioning outlet 100 according to a height of the second mark 222 on the first mark 221 while acquiring left-right air outlet information of the air conditioning outlet 100 through the first mark 221. Accordingly, the number of pieces of the air outlet state information acquired by the user at the same time can be increased, the number of times of head lowering during parameter viewing can be reduced, the driving safety can be improved, and the user experience can be improved.

In some embodiments, similar to the first mark 221 in FIG. 5, the first mark 221 extends in the vehicle-width direction X, and an inclination direction of the first mark 221 relative to the vehicle-height direction Y is used to indicate the up-down air outlet direction of the air conditioning outlet 100. The second mark 222 is arranged on the first mark 221, and a position where the second mark 222 is present on the first mark 221 in the vehicle-width direction X is used to indicate a left-right air outlet direction of the air conditioning outlet 100. As described above, the second mark 222 is provided on the first mark 221, thereby allowing the user to confirm left-right air outlet information of the air conditioning outlet 100 according to the position where the second mark 222 is present on the first mark 221 while acquiring up-down air outlet information of the air conditioning outlet 100 through the first mark 221. Accordingly, the number of pieces of the air outlet state information acquired by the user at the same time can be increased, the number of times of head lowering during parameter viewing can be reduced, the driving safety can be improved, and the user experience can be improved.

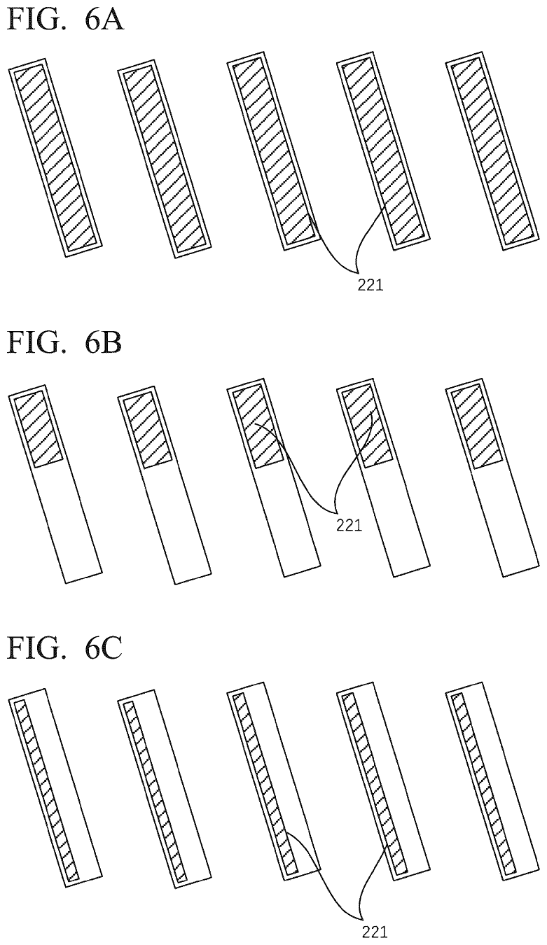

FIGS. 6A, 6B, and 6C are schematic diagrams of changes of the first mark 221 in FIG. 1 when an air outlet volume decreases, in which FIG. 6A is an enlarged view of the first mark 211 displayed by the indication unit 210 in FIG. 1, FIG. 6B is a schematic diagram of a change of the first mark 211 after the air volume of the air conditioning outlet 100 in FIG. 1 is decreased, and FIG. 6C is another schematic diagram of the change of the first mark 211 after the air volume of the air conditioning outlet 100 in FIG. 1 is decreased. As shown in FIGS. 6A, 6B, and 6C, in some embodiments, a size of the first mark 221 is used to indicate the air outlet volume of the air conditioning outlet 100. Specifically, the size of the first mark 221 includes at least one of an area, a length, and a width of the first mark 221. As described above, the user can more intuitively acquire air outlet volume information of the air conditioning outlet 100 through the size of the first mark 221, thereby reducing a think time of the user and improving the user experience. In addition, the air outlet volume information can be displayed through the first mark 221 while the air outlet direction is displayed through the first mark 221. Accordingly, the number of pieces of the air outlet state information acquired by the user at the same time can be increased, the number of times of head lowering during parameter viewing can be reduced, the driving safety can be improved, and the user experience can be improved.

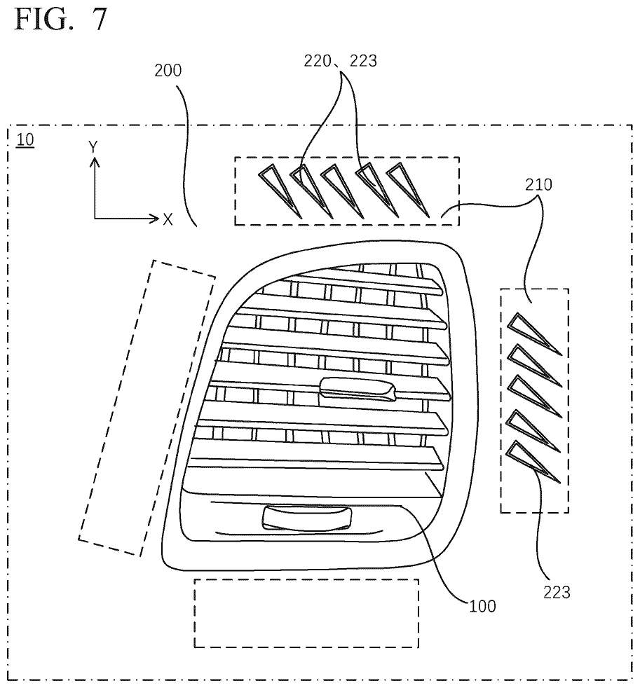

FIG. 7 is a schematic structural diagram of an in-vehicle air conditioning outlet state indicator 10 according to a fifth embodiment of this application. As shown in FIG. 7, in some embodiments, the indication mark 220 includes at least one third mark 223 with a gradually changing width, and a direction in which the width of the third mark 223 gradually changes is used to indicate the air outlet direction of the air conditioning outlet 100. As described above, the air outlet direction of the air conditioning outlet 100 is indicated by the direction in which the width of the third mark 223 gradually changes, so that the air outlet direction information of the air conditioning outlet 100 can be displayed to the user more intuitively, thereby allowing the user to conveniently confirm the air outlet direction of the air conditioning outlet 100, reducing the number of times of head lowering during parameter viewing, improving the driving safety, and improving the user experience.

As shown in FIG. 7, in some embodiments, the width of the third mark 223 gradually changes in the vehicle-height direction Y, and a direction in which the width of the third mark 223 decreases indicates the up-down air outlet direction of the air conditioning outlet 100. As described above, the width of the third mark 223 gradually changes in the vehicle-height direction Y, thereby forming an arrow shape toward the up-down direction. Accordingly, it is possible for the user to conveniently confirm the up-down air outlet direction of the air conditioning outlet 100.

In some embodiments, the width of the third mark 223 gradually changes in the vehicle-height direction Y, and a direction in which the width of the third mark 223 increases indicates the up-down air outlet direction of the air conditioning outlet 100. As described above, the width of the third mark 223 gradually changes in the vehicle-height direction Y, thereby forming a horn shape toward the up-down direction. Accordingly, it is possible for the user to conveniently confirm the up-down air outlet direction of the air conditioning outlet 100.

As shown in FIG. 7, in some embodiments, the width of the third mark 223 gradually changes in the vehicle-width direction X, and a direction in which the width of the third mark 223 decreases indicates the left-right air outlet direction of the air conditioning outlet 100. As described above, the width of the third mark 223 gradually changes in the vehicle-width direction X, thereby forming an arrow shape toward the left-right direction. Accordingly, it is possible for the user to conveniently confirm the left-right air outlet direction of the air conditioning outlet 100.

As shown in FIG. 7, in some embodiments, the width of the third mark 223 gradually changes in the vehicle-height direction Y, and a direction in which the width of the third mark 223 decreases indicates the up-down air outlet direction of the air conditioning outlet 100. As described above, the width of the third mark 223 gradually changes in the vehicle-height direction Y, thereby forming an arrow shape toward the up-down direction. Accordingly, it is possible for the user to conveniently confirm the up-down air outlet direction of the air conditioning outlet 100. As shown in FIG. 7, in some embodiments, the air outlet direction of the air conditioning outlet 100 may also be indicated according to an inclination direction of the third mark 223. Specifically, for example, as shown in FIG. 7, when the width of the third mark 223 in the vehicle-height direction Y gradually changes, the user determines that the air outlet direction of the air conditioning outlet 100 inclines to the right according to that one end with a smaller width of the third mark 223 above the air conditioning outlet 100 inclines to the right. When the width of the third mark 223 in the vehicle-width direction X gradually changes, the user determines that the air outlet direction of the air conditioning outlet 100 inclines downward according to that one end with a smaller width of the third mark 223 on the right side of the air conditioning outlet 100 inclines downward. Therefore, the number of pieces of the air outlet state information acquired by the user at the same time can be increased, the number of times of head lowering during parameter viewing can be reduced, the driving safety can be improved, and the user experience can be improved.

In some embodiments, the width of the third mark 223 gradually changes in the vehicle-width direction X, and a direction in which the width of the third mark 223 increases indicates the left-right air outlet direction of the air conditioning outlet 100. As described above, the width of the third mark 223 gradually changes in the vehicle-width direction X, thereby forming a horn shape toward a left-right direction. Accordingly, it is possible for the user to conveniently confirm the left-right air outlet direction of the air conditioning outlet 100.

In some embodiments, the air outlet direction of the air conditioning outlet 100 may also be indicated according to an inclination direction of one end with a larger width of the third mark 223. Specifically, the third mark 223 is in a horn shape, and the user determines the air outlet direction of the air conditioning outlet 100 according to the inclination direction of the one end (that is, the end of horn mouth) with a larger width of the third mark 223. Accordingly, the number of pieces of the air outlet state information acquired by the user at the same time can be increased, the number of times of head lowering during parameter viewing can be reduced, the driving safety can be improved, and the user experience can be improved.

In some embodiments, the width of the third mark 223 gradually changes in the vehicle-height direction Y, the second mark 222 is arranged on the third mark 223, and a position where the second mark 222 is present on the third mark 223 in the vehicle-height direction Y is used to indicate the up-down air outlet direction of the air conditioning outlet 100.

In some embodiments, the width of the third mark 223 gradually changes in the vehicle-width direction X, the second mark 222 is arranged on the third mark 223, and a position where the second mark 222 is present on the third mark 223 in the vehicle-width direction X is used to indicate the left-right air outlet direction of the air conditioning outlet 100.

In some embodiments, the indication mark 220 includes at least one fourth mark (not shown) for flow display, swing display, or rotation display, for example, the fourth mark may be set to be a graphic shape capable of indicating a direction, such as a colored flag shape, a ribbon shape, a windmill shape, a waterflow shape, or a wind ripple shape, and a direction of the flow display, the swing display, or the rotation display of the fourth mark is used to indicate the air outlet direction of the air conditioning outlet 100. As described above, the indication mark 220 dynamically indicates the air outlet direction of the air conditioning outlet 100 through the fourth mark for flow display, swing display, or rotation display, thereby allowing the user to conveniently confirm the air outlet direction of the air conditioning outlet 100, and improving the user experience.

In some embodiments, the indication mark 220 includes at least two types of marks, and a combination of the at least two types of marks can be used to indicate at least the left-right air outlet direction and the up-down air outlet direction of the air conditioning outlet 100. As described above, a combination of any two or more indication marks 220 can be used to indicate the air outlet direction of the air conditioning outlet 100 in a more diversified manner, meanwhile, one of any two indication marks 220 can be used to indicate the left-right air outlet direction, and the other of the any two indication marks can be used to indicate the up-down air outlet direction. With such an arrangement, the air outlet direction is displayed more perfectly and the display is more interesting.

Meanwhile, it is possible for the user to confirm the air outlet direction of the air conditioning outlet 100 more conveniently, the number of times of head lowering during parameter viewing can be reduced, the driving safety can be improved, and the user experience can be improved.

In some embodiments, a color of the indication unit 210 is used to indicate an air outlet temperature of the air conditioning outlet 100. As described above, the user can determine the air outlet temperature of the air conditioning outlet 100 by the color of the indication unit 210, so that the air outlet temperature information of the air conditioning outlet 100 can be displayed to the user more intuitively, thereby allowing the user to conveniently confirm the air outlet temperature of the air conditioning outlet 100. Further, a type of the state information of the air conditioning outlet 100 included in the indication unit 210 can be increased, the number of times of head lowering during parameter viewing can be reduced, the driving safety can be improved, and the user experience can be improved.

As shown in FIGS. 1 to 7, the indication unit 210 is located at a position around the air conditioning outlet 100. As described above, the indication unit 210 is provided at the position around the air conditioning outlet 100, so that the user is allowed to conveniently confirm state information of a corresponding air conditioning outlet 100 after the indication unit 210 displays the indication mark 220, thereby improving the user experience.

In some embodiments, the air conditioning outlet 100 is provided with a sensor (not shown) for detecting at least one of the air outlet direction, an air outlet temperature, and an air outlet volume. As described above, the air outlet direction, the air outlet temperature, and the air outlet volume of the air conditioning outlet 100 can be detected in real time, and the detected data is fed back to a controller (not shown), so that a change of the indication mark 220 is adjusted based on real-time data, thereby improving the accuracy of displaying the air outlet information of the air conditioning outlet 100.

In some embodiments, the indication unit 210 is activated to enter the working state based on a detection result of the sensor. As described above, the indication unit 210 can display the air outlet information of the air conditioning outlet 100 in time, thereby improving the user experience.

In some embodiments, the indication unit 210 is activated to enter the working state when the air conditioning outlet 100 is in an open state. As described above, the indication unit 210 can display the air outlet information of the air conditioning outlet 100 in time, thereby improving the user experience.

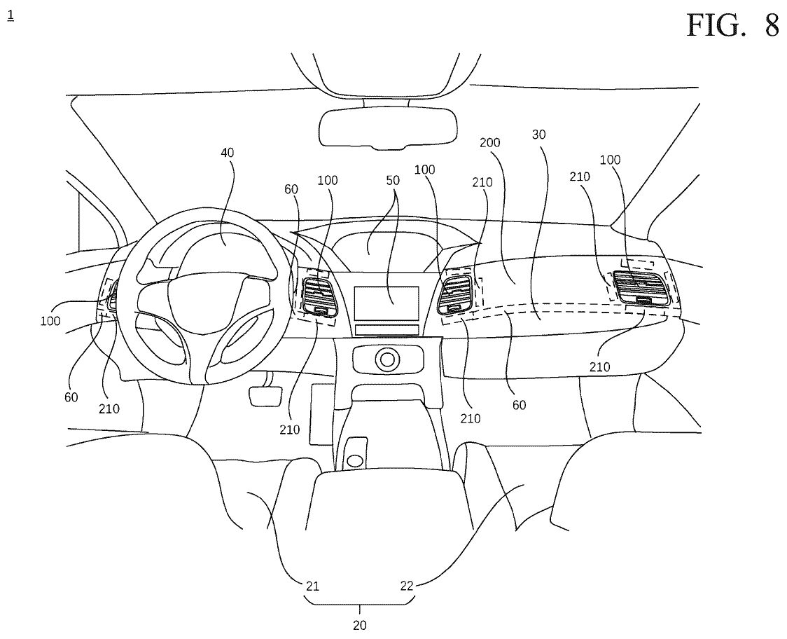

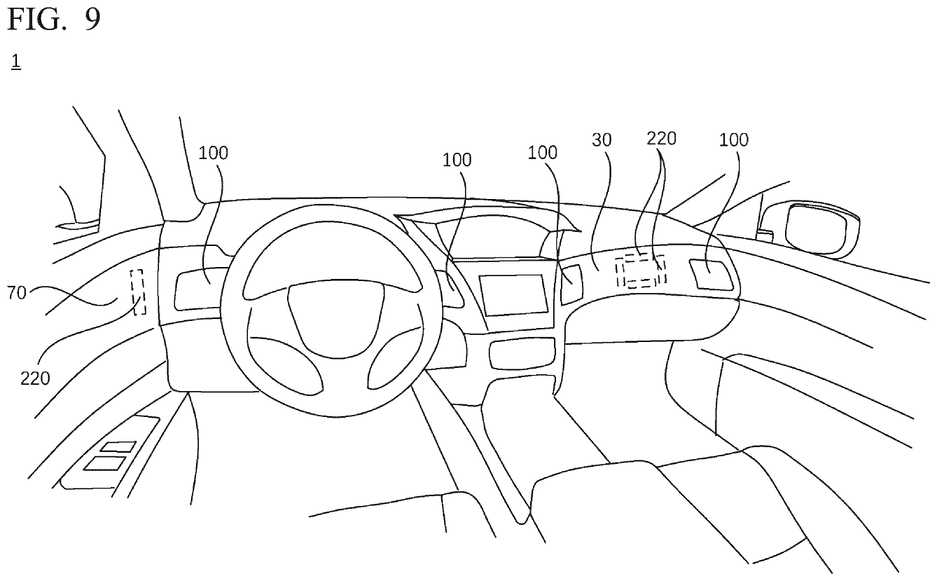

FIG. 8 is a schematic structural diagram of a vehicle 1 according to an embodiment of this application. FIG. 9 is a schematic structural diagram of a driver visual angle of the vehicle 1 in FIG. 8. As shown in FIG. 8 and FIG. 9, in some embodiments, the indication unit 210 may also be arranged on the instrument panel 30, for example, arranged on the instrument panel 30 at a position facing the front of the seat 20 of a driver seat or a passenger seat, thereby allowing the driver and a passenger sitting on the seat 20 of the passenger seat to conveniently observe. The indication unit 210 may also be arranged on, for example, a door panel 70 shown in FIG. 9 or at another suitable position on the vehicle door, thereby allowing a passenger to conveniently observe. The indication unit 210 may also be arranged on the central console armrest, and in a case where the air conditioning outlet 100 is disposed at one end of the central console armrest facing the rear seat, by arranging the indication unit 210 on the central console armrest, a passenger sitting on the rear seat is allowed to conveniently observe, thereby acquiring air outlet information of the air conditioning outlet 100 facing the rear seat. The indication unit 210 may also be arranged on a backrest of the seat, so that the passenger sitting on the rear seat is allowed to conveniently observe, thereby acquiring the air outlet information of the air conditioning outlet 100 facing the rear seat. Alternatively, the indication unit 210 may also be arranged at other positions convenient for the user to observe, which is not limited.

In some embodiments, in a case where each of a left side and a right side in front of the seat 20 of the driver seat or the passenger seat is provided with an air conditioning outlet 100 corresponding to the seat 20, when the driver seat has two air outlets on the left and the right, the indication unit 210 may be arranged in a middle position of the air outlets on the left and the right as shown in FIG. 9, thereby allowing the user to conveniently observe. The indication unit 210 may display the air outlet information of the two air conditioning outlets 100 on one panel, or may display the air outlet information of the two air conditioning outlets 100 on two panels, respectively.

In some embodiments, the indication unit 210 includes a sleep state, and the indication mark 220 is hidden when the indicator 210 is in the sleep state. The indication unit 210 enters the sleep state after maintaining the working state for a predetermined period of time. As described above, the indication unit 210 enters the sleep state after maintaining the working state for the predetermined period of time, so that energy consumption of the indication unit 210 can be reduced, thereby saving electric energy.

In some embodiments, the indication unit 210 can be switched from the sleep state to the working state by any means of voice, button, touch, gesture, and sight. As described above, when the user needs to know the state information of the air conditioning outlet 100, the indication unit 210 may enter the working state by means of voice, button, touch, gesture, sight, and the like, thereby displaying the indication mark 220 to display the state information of the air conditioning outlet 100. Accordingly, it is possible for the user to use, and the user experience is improved.

In some embodiments, when the indication unit 210 is in the sleep state and the user adjusts a state of the air conditioning outlet 100, the indication unit 210 corresponding to the air conditioning outlet 100 enters the working state to display the indication mark 220, or the indication unit 210 enters the working state when the indication unit 210 is in the sleep state and approaching of a user is sensed. As described above, when the user adjusts the air conditioning outlet 100, the user can conveniently know a state of the air conditioning outlet 100 after the adjustment, thereby facilitating operations of the user. Meanwhile, the indication unit 210 can enter the working state when approaching of a user is sensed, which is convenient for the user to view.

As shown in FIG. 8, in some embodiments, the interior trim panel 200 is provided with an ambient light 60, and the indication unit 210 includes at least a part of the ambient light 60. As described above, the indication unit 210 and the ambient light 60 may be combined together, thereby improving the user experience.

In some embodiments, the interior trim panel 200 is provided with an ambient light 60, and a display mode of the ambient light 60 is linked with the indication mark 220. Specifically, the ambient light 60 is linked with a display color of the indication mark 220, that is, the ambient light 60 and the indication mark 220 have the same color, or the display colors of the ambient light 60 and the indication mark 220 may change according to a certain rule. The ambient light 60 is linked with a display pattern of the indication mark 220, that is, the ambient light 60 is linked with the indication mark 220 to form a uniform or associated pattern. For example, when the indication mark 220 is a flowing waterflow pattern, the ambient light 60 also displays a waterflow pattern, and a direction of the waterflow pattern displayed by the ambient light 60 is consistent with a direction of the waterflow pattern displayed by the indication mark 220. As described above, the ambient light is linked with the indication mark, so that light patterns on the interior trim panel can be more coordinated and flexible, thereby improving the aesthetics of the interior trim panel, and improving the user experience.

In some embodiments, the ambient light 60 and the indication unit 210 are independent of each other, so as to prevent the ambient light 60 from interfering with the indication unit 210 and affecting the user determining the state information of the air conditioning outlet 100 through the indication unit 210.

In some embodiments, the indication mark 220 is a light-emitting pattern that changes statically or dynamically. As described above, by using the light-emitting pattern that changes statically or dynamically as the indication mark, the indication mark 220 is more plentiful, the light-emitting pattern is more intuitive, and a user can conveniently acquire information, thereby improving the user experience.

In some embodiments, the indication unit 210 may be formed by a screen, a display panel, a light-transmitting panel, a light-transmitting skin, and the like, or may be formed by an array of LED lamps, and the air direction of the air conditioning outlet 100 may be indicated by selective on-off control or turn-on time sequential control.

In some embodiments, the air outlet direction of the air conditioning outlet 100 at least includes the left-right air outlet direction and the up-down air outlet direction, and the indication mark 220 is used to indicate at least one of the air outlet directions. As described above, various air outlet directions of the air conditioning outlet 100 can all be displayed by the indication mark 220, a user can acquire any information desired to be acquired by the indication mark 220, which is more comprehensive, and the most important air outlet information on the up-down direction and left-right direction can be acquired in time for the user, and the directions can be adjusted in time based on actual requirements.

In some embodiments, the indication mark 220 is able to be set by user selection or a customized setting. As described above, the indication mark 220 is not fixed, and may include various types of modes or styles, which are selected and set by the user based on his/her own preferences or habits, so as to better meet the requirements of the user. Certainly, the user may also make a customized design, and use a solution designed by the user as an indication mark 220, thereby meeting a personalized use requirement of the user to the greatest extent.

In some embodiments, a change of the air outlet direction of the air conditioning outlet 100 includes any of the following: a change of the air outlet direction of the air conditioning outlet 100 caused by the user manually adjusting the air outlet direction of the air conditioning outlet 100; a change of the air outlet direction of the air conditioning outlet 100 caused by an automatic adjustment of the air conditioning outlet 100; and an adjustment of the air outlet direction of the air conditioning outlet 100 caused by the user adjusting the display state of the indication mark 220. As described above, the change of the air outlet direction of the air conditioning outlet 100 may include various situations, such as a manual adjustment, an automatic adjustment, or an adjustment of the air outlet direction by adjusting the indication mark 220. In any case, as long as there is a change in the air outlet direction, it can be displayed by the indication mark 220, which is an intuitive and convenient information acquisition manner for the user.

In some embodiments, one indication unit 210 is able to be used to indicate current air outlet directions of at least two air conditioning outlets 100. Even when there are more air conditioning outlets, air outlet states thereof can be displayed by using as few indication units 210 as possible, thereby reducing the number of the indication units 210, which has an advantage in cost.

This application further provides a vehicle 1, and hereinafter, a specific structure of the vehicle 1 of this application will be described in detail with reference to the drawings.

FIG. 8 is the schematic structural diagram of the vehicle 1 according to an embodiment of this application. As shown in FIG. 8, the vehicle 1 of this application includes at least one seat 20. The vehicle 1 further includes the in-vehicle air conditioning outlet state indicator 10 according to any one of the above-described embodiments, in which the seat 20 is provided corresponding to at least one air conditioning outlet 100 and at least one indication unit 210.

In some embodiments, the air conditioning outlet 100 corresponding to the seat 20 is in an open state, and when a user sits on the seat 20, the indication unit 210 corresponding to the seat 20 enters the working state. As described above, the indication unit 210 is in the open state at the air conditioning outlet 100, and enters the working state when a user sits on the corresponding seat 20, so that energy consumption of the indication unit 210 can be reduced, thereby saving electric energy. Meanwhile, the indication unit 210 enters the working state after the user sits on the seat, so that it is possible for the user to conveniently know the state information of the air conditioning outlet 100, thereby improving the user experience.

Whether a user sits on the seat 20 may be detected by using a camera in a vehicle cabin or a pressure sensor arranged in a seat cushion, which is not limited herein.

In some embodiments, the indication unit 210 is located within an observable range of a user sitting on the seat 20 when the user looks straight ahead. As described above, by providing the indication unit 210 within the range observable in the sight of the front view of the user, a driving risk caused by the user lowering head or diverting sight to view the state information of the air conditioning outlet 100 can be avoided. Accordingly, the driving safety can be improved, and the user experience can be improved. Preferably, the indication unit 210 may be arranged at a position above the air conditioning outlet 100, so that the indication unit 210 is close to the center of the user's field of view when the user looks straight ahead, thereby allowing the user to see the indication unit 210 more clearly when looking straight ahead.

In some embodiments, the vehicle 1 includes a driver seat 21, a passenger seat 22, and a rear seat, and the indication unit 210 corresponding to the driver seat 21 is located on an instrument panel 30 on a side of the vehicle 1 close to the driver seat 21, or, the indication unit 210 corresponding to the passenger seat 22 is located on an instrument panel 30 on a side of the vehicle 1 close to the passenger seat 22 or located at an inner side of a vehicle door on the side of the passenger seat 22, or, the indication unit 210 corresponding to the rear seat is located at a back portion of the driver seat 21 or the passenger seat 22, or located at an inner side of a vehicle door closest to the rear seat or at a rear end of a front central console armrest. As described above, users sitting on the driver seat 21, the passenger seat 22, and the rear seat can acquire the air outlet information of the air conditioning outlet 100 more conveniently, so that the user experience can be improved.

In some embodiments, the vehicle 1 includes a plurality of interior trim panels 200 corresponding to a plurality of the seats 20, and a plurality of the indication units 210 corresponding to the plurality of the seats 20 in the vehicle 1 are arranged on the same interior trim panel 200, or the plurality of the indication units 210 corresponding to the plurality of the seats 20 in the vehicle 1 are respectively arranged on different interior trim panels 200, or at least two indication units 210 among the plurality of the indication units 210 corresponding to the plurality of seats 20 in the vehicle 1 are arranged on the same interior trim panel 200. As described above, the plurality of indication units 210 corresponding to the plurality of air conditioning outlets 100 may be located on different interior trim panels 200, respectively, which facilitates each user to view the information, respectively, and two or more indication units 210 may also be provided on the same interior trim panel 200, which allows one user to integrally grasp states of more indication units 210, and selections can be made based on different user requirements.

In some embodiments, the vehicle 1 includes a plurality of the interior trim panels 200 corresponding to the plurality of the seats 20, and a user can set one or more of the indication units 210 to any of the plurality of the interior trim panels 200 by himself/herself. Specifically, for example, when passengers in the vehicle are all adults, the indication units 210 may be located on an interior trim panel 200 near each of the seats 20, respectively, and each of the adults may view and adjust by himself/herself. When a child is sitting on the seat 20 in the vehicle 1, adults sitting on other seats 20 need to pay attention to a state of an air outlet corresponding to the child and adjust the air outlet in time, in this case, the indication unit 210 corresponding to the child may be adjusted to an interior trim panel corresponding to a position of the seat 20 where an adult sits on. As described above, a position of the indication unit 210 may be set based on actual requirements of the user, thereby meeting different requirements of different users, which is more friendly to the user.

In some embodiments, the vehicle 1 further includes a control unit (not shown), the control unit is electrically connected to the indication unit 210, and the control unit controls the indication mark 220 displayed by the indication unit 210 to change correspondingly according to state data such as the air outlet direction, the air volume, and the air outlet temperature of the air conditioning outlet 100.

The above contents describe possible embodiments of the in-vehicle air conditioning outlet state indicator 10 and the vehicle 1 of this application with reference to FIGS. 1 to 8. Hereinafter, specific structures of the in-vehicle air conditioning outlet state indicator 10 and the vehicle 1 of this application will be described in detail in a specific embodiment with reference to the drawings.

As shown in FIG. 8, the vehicle 1 of this application includes the driver seat 21 and the passenger seat 22 arranged side by side on the left and right at a front position in the compartment of the vehicle 1, and the instrument panel 30 is arranged in front of the driver seat 21 and the passenger seat 22. An instrument screen 40 is arranged at a position close to a left side of the instrument panel 30 (a position corresponding to the driver seat 21), the instrument screen 40 is used to display information such as vehicle speed and oil amount, a vehicle machine screen 50 is arranged in a middle portion of the instrument panel 30, and the vehicle machine screen 50 is used to display navigation information and the like, and further display information related to the air conditioning outlet. The instrument panel 30 is further provided with four air conditioning outlets 100, two air conditioning outlets 100 among which are located on positions at both sides corresponding to the driver seat 21 on the instrument panel 30 (that is, on positions at both sides of the instrument screen 40), and the other two air conditioning outlets 100 are located on both sides corresponding to the passenger seat 22 on the instrument panel 30. Therefore, after the user sits on the driver seat 21 or the passenger seat 22, there is an air conditioning outlet 100 on each of both sides in front of the user to blow air to the user. The user can adjust the state of the air conditioning outlet 100 by clicking a corresponding button and pattern on the vehicle machine screen 50, and by adjusting the air outlet state information such as the air outlet direction, the air outlet volume, and the air outlet temperature of the air conditioning outlet 100, the user can feel more comfortable.

The instrument panel 30 is provided with the interior trim panel 200 for trimming the instrument panel 30, the air conditioning outlet 100 is provided on the interior trim panel 200, and the interior trim panel 200 is provided with indication units 210 surrounding the air conditioning outlet 100 at corresponding positions on upper, lower, left, and right sides of the air conditioning outlet 100. The indication unit 210 is formed by an array of LED lamps and includes a working state and a sleep state. When the indication unit 210 is in the sleep state, the LED lamps are kept in an all-off state, and in this case, the indication unit 210 is in a hidden state on the interior trim panel 200. Accordingly, electric energy can be saved, and an influence of the indication unit 210 on an appearance of the interior trim panel 200 is avoided. When the indication unit 210 is in the working state, the indication unit 210 displays the indication mark 220 through on/off of the LED lamps, and the indication mark 220 is used for indicating a current state of the air conditioning outlet 100.

Specifically, when the air conditioning outlet 100 blows air out and it is detected that a user sits on the driver seat 21 or the passenger seat 22, the indication unit 210 around the air conditioning outlet 100 corresponding to the driver seat 21 or the passenger seat 22 on which the user sits enters the working state. When the air conditioning outlet 100 blows air out but it is not detected that a user sits on the driver seat 21 or the passenger seat 22, the corresponding indication unit 210 around the air conditioning outlet 100 enters the sleep state. When the air conditioning outlet 100 blows air out and it is detected that a seating period of the user sitting on the driver seat 21 or the passenger seat 22 exceeds a predetermined period of time (the predetermined period of time may be adjusted by the user to 1 minute, 2 minutes, or other periods of time through the vehicle machine screen 50), the indication unit 210 enters the sleep state. When the indication unit 210 is in the sleep state and the user adjusts the air outlet state of one air conditioning outlet 100, the indication units 210 around the air conditioning outlet 100 and all air conditioning outlets 100 corresponding to the corresponding driver seat 21 or passenger seat 22 enter the working state. For example, when the user sitting on the passenger seat 22 adjusts the air outlet state of one air conditioning outlet 100 corresponding to the passenger seat 22, the indication units 210 around the two air conditioning outlets 100 corresponding to the passenger seat 22 enter the working state.

In the working state, the indication unit 210 may display a dynamic or static indication mark 220 by selective on-off control or turn-on time sequential control, thereby displaying the air outlet direction, the air outlet volume, and the air outlet temperature of the air conditioning outlet 100 surrounded by the indication unit 210. The user may select a form of the indication mark 220 displayed by the indication unit 210 in the working state through the vehicle machine screen 50, and specifically, may select any of display forms of the indication mark 220 in FIGS. 1 to 5 and 7.

The user may also select, through the vehicle machine screen 50, an indication unit 210 allowed to enter the working state from the four indication units 210 surrounding the air conditioning outlet 100 on upper, lower, left, and right sides, so that one or more of the indication units 210 surrounding the air conditioning outlet 100 on upper, lower, left, and right sides is allowed to enter the working state, thereby forming display forms shown in FIGS. 1 to 5 and 7 in the working state. Therefore, the user can personalize selection and settings according to his/her own preferences, thereby improving the user experience.

FIG. 1 shows a specific display form of the indication unit 210 around one air conditioning outlet 100 in a default state. As shown in FIG. 1, in the default state, the vehicle 1 only allows the indication unit 210 located below the air conditioning outlet 100 to enter the working state to display the indication mark 220. The indication mark 220 includes a plurality of first marks 221 extending along the vehicle-height direction Y, and a plurality of the first marks 221 are arranged and disposed along the vehicle-width direction X. One end of the first mark 221 away from the air conditioning outlet 100 may incline to the left or right along with the air outlet direction of the air conditioning outlet 100, thereby allowing the user to conveniently confirm whether the air outlet direction of the air conditioning outlet 100 is leftward or rightward.

The display form of the indication units 210 around the air conditioning outlet 100 may be changed, as shown in FIGS. 2, 3A and 3B, the user may set the indication unit 210 through the vehicle machine screen 50, and may select indication units 210 located on upper, lower, left, and right sides of the air conditioning outlet 100 to be all allowed to enter the working state to display the indication mark 220. The indication mark 220 includes a plurality of first marks 221, among which first marks 221 in the indication units 210 located at positions of upper and lower of the air conditioning outlet 100 extend along the vehicle-height direction Y, and a plurality of the first marks 221 are arranged and disposed along the vehicle-width direction X. One end of the first mark 221 away from the air conditioning outlet 100 may incline to the left or right along with the air outlet direction of the air conditioning outlet 100, thereby allowing the user to conveniently confirm whether the air outlet direction of the air conditioning outlet 100 is leftward or rightward. The first marks 221 in the indication units 210 located at positions on left and right sides of the air conditioning outlet 100 extend along the vehicle-width direction X, and a plurality of the first marks 221 are arranged and disposed along the vehicle-height direction Y. One end of the first mark 221 away from the air conditioning outlet 100 may incline upward or downward along with the air outlet direction of the air conditioning outlet 100, thereby allowing the user to conveniently confirm whether the air outlet direction of the air conditioning outlet 100 is upward or downward.

As shown in FIG. 4, the user may set the indication unit 210 through the vehicle machine screen 50, and may select the indication units 210 on the right side and the lower side of the air conditioning outlet 100 to be allowed to enter the working state, and at the same time switch the plurality of first marks 221 in the indication unit 210 to one first mark 221. Specifically, the first mark 221 located on the right side of the air conditioning outlet 100 extends along the up-down direction, and may swing left and right with an upper end thereof as the center, and the user may determine the left-right air outlet direction of the air conditioning outlet 100 according to a left-right inclination direction of a lower end of the first mark 221. The first mark 221 arranged below the air conditioning outlet 100 extends along the left-right direction, and may swing up and down with a left end thereof as the center, and the user may determine the up-down air outlet direction of the air conditioning outlet 100 according to an up-down inclination direction of a right end of the first mark 221.

As shown in FIG. 5, the user may set the indication unit 210 through the vehicle machine screen 50, and may select the indication unit 210 on the upper side of the air conditioning outlet 100 to be allowed to enter the working state. Meanwhile, the user may also add a second mark 222 to the indication unit 210 through the vehicle machine screen 50, the second mark 222 is arranged on the first mark 221, and a position of the second mark 222 on the first mark 221 in the vehicle-height direction Y is used to indicate the up-down air outlet direction of the air conditioning outlet 100. Specifically, when the second mark 222 is close to an upper end position of the first mark 221 on the first mark 221, it indicates that the air outlet direction of the air conditioning outlet 100 inclines upward. When the second mark 222 is close to a lower end position of the first mark 221 on the first mark 221, it indicates that the air outlet direction of the air conditioning outlet 100 inclines downward. As described above, by providing the second mark 222 on the first mark 221, the user is allowed to confirm up-down air outlet information of the air conditioning outlet 100 according to a height of the second mark 222 on the first mark 221 while acquiring left-right air outlet information of the air conditioning outlet 100 through the first mark 221. Accordingly, the number of pieces of the air outlet state information acquired by the user at the same time can be increased, the number of times of head lowering during parameter viewing can be reduced, the driving safety can be improved, and the user experience can be improved.

As shown in FIG. 7, the user may set the indication unit 210 through the vehicle machine screen 50, and may select the indication units 210 on the upper side and the right side of the air conditioning outlet 100 to be allowed to enter the working state. Meanwhile, the user may also replace the first mark 221 in the indication unit 210 with a third mark 223 through the vehicle machine screen 50. The third mark 223 has a triangular arrow shape, and a direction (a direction in which a width thereof gradually decreases) indicated by the arrow of the third mark 223 is used to indicate the air outlet direction of the air conditioning outlet 100. Specifically, as shown in FIG. 7, the direction of the arrow of the third mark 223 in the indication unit 210 above the air conditioning outlet 100 is downward, that is, the air outlet direction of the air conditioning outlet 100 is downward. The direction of the arrow of the third mark 223 in the indication unit 210 on the right side of the air conditioning outlet 100 is rightward, that is, the air outlet direction of the air conditioning outlet 100 is rightward.

As shown in FIG. 7, the air outlet direction of the air conditioning outlet 100 may also be indicated according to an inclination direction of one end (one end with a smaller width) of the arrow of the third mark 223. Specifically, it may be, for example, as shown in FIG. 7, that the user determines that the air outlet direction of the air conditioning outlet 100 inclines to the right according to that the arrow of the third mark 223 above the air conditioning outlet 100 inclines to the right. The user determines that the air outlet direction of the air conditioning outlet 100 inclines downward according to that the arrow of the third mark 223 on the right side of the air conditioning outlet 100 inclines downward. Accordingly, the number of pieces of the air outlet state information acquired by the user at the same time can be increased, the number of times of head lowering during parameter viewing can be reduced, the driving safety can be improved, and the user experience can be improved.

Further, sizes of the first mark 221 and the third mark 223 may also indicate the air outlet volume of the air conditioning outlet 100. Specifically, the size of the first mark 221 includes any one or more forms of an area, a length, and a width of the first mark 221, and the user may select a display form of the air outlet volume of the air conditioning outlet 100 through the vehicle machine screen 50. For example, the user may select to determine the air outlet volume of the air conditioning outlet 100 according to lengths of the first mark 221 and the third mark 223, and the longer the extending lengths of the first mark 221 and the third mark 223, the larger the air outlet volume of the air conditioning outlet 100. As described above, the user can more intuitively acquire the air outlet volume information of the air conditioning outlet 100 through the size of the first mark 221, and in addition, the air outlet volume information can be displayed through the first mark 221 and the third mark 223 while the air outlet direction is displayed through the first mark 221 and the third mark 223. Accordingly, the number of pieces of the state information of the air conditioning outlet 100 acquired by the user at the same time can be increased, the number of times of head lowering during parameter viewing can be reduced, the driving safety can be improved, and the user experience can be improved.

Further, the air outlet temperature of the air conditioning outlet 100 may also be indicated by the color of the indication mark 220, and different colors displayed by the indication mark 220 correspondingly represent different air outlet temperatures of the air conditioning outlet 100. For example, when the air outlet temperature of the air conditioning outlet 100 is lower than a temperature in the compartment, the color of the indication mark 220 is blue, and the lower the temperature, the darker the blue displayed by the indication mark 220. When the air outlet temperature of the air conditioning outlet 100 is equal to or higher than the temperature in the compartment, the color of the indication mark 220 is red, and the higher the temperature, the darker the red displayed by the indication mark 220. As described above, the user can determine the air outlet temperature of the air conditioning outlet 100 by the color of the indication mark 220, so that the air outlet temperature information of the air conditioning outlet 100 can be displayed to the user more intuitively, thereby allowing the user to conveniently confirm the air outlet temperature of the air conditioning outlet 100. Further, a type of the state information of the air conditioning outlet 100 included in the indication mark 220 can be increased, the number of times of head lowering during parameter viewing can be reduced, the driving safety can be improved, and the user experience can be improved.

Further, when the user selects the display pattern of the indication unit 210 through the vehicle machine screen 50, a fourth mark (not shown) for flow display, swing display or rotation display may also be selected, specifically, the fourth mark may be a graphic shape that may indicate a direction such as a color flag, a ribbon, a windmill, a water flow, and a wind grain, and a direction of the flow display, the swing display, or the rotation display of the fourth mark is used to indicate the air outlet direction of the air conditioning outlet 100. As described above, the indication unit 210 dynamically indicates the air outlet direction of the air conditioning outlet 100 through the fourth mark for flow display, swing display, or rotation display, thereby allowing the user to conveniently confirm the air outlet direction of the air conditioning outlet 100, and improving the user experience.

With reference to the above descriptions and the drawings, it can be known that, in an embodiment of the in-vehicle air conditioning outlet state indicator 10 and the vehicle 1 of this application, the in-vehicle air conditioning outlet state indicator 10 includes the air conditioning outlet 100 and the interior trim panel 200. The air outlet direction of the air conditioning outlet 100 is changeable, and the interior trim panel 200 includes the indication unit 210 displaying, in the working state, the indication mark 220 used for indicating a current air outlet direction of the air conditioning outlet 100, in which when the air outlet direction of the air conditioning outlet 100 changes, the indication mark 220 also changes. As described above, by providing the indication unit 210 in the interior trim panel 200, and indicating the air outlet direction of the air conditioning outlet 100 by the indication mark 220, the display of the air outlet direction information of the air conditioning outlet 100 can be separated from the vehicle machine screen 50, thereby avoiding an annoyance to the user due to other information on the vehicle machine screen 50. The user can directly acquire the air outlet direction information of the air conditioning outlet 100 according to the indication mark 220, without distinguishing among a large amount of information. Accordingly, it is possible for the user to conveniently acquire the state parameter of the air conditioning outlet 100, the number of times of head lowering during parameter viewing can be reduced, the driving safety can be improved, and the user experience can be improved.

The indication mark 220 includes a plurality of first marks 221 extending in the vehicle-height direction Y, and an inclination direction of the first marks 221 extending in the vehicle-height direction Y relative to the vehicle-width direction X indicates the left-right air outlet direction of the air conditioning outlet 100. When the air direction of the air conditioning outlet 100 shifts to the right, the first marks 221 located above and below the air conditioning outlet 100 will rotate correspondingly, and an upper end of the first mark 221 located above the air conditioning outlet 100 will incline to the right, a lower end of the first mark 221 located below the air conditioning outlet 100 will incline to the right. Accordingly, the user can confirm the left-right air outlet direction of the air conditioning outlet 100 according to the left-right inclination direction of the first mark 221, thereby allowing the user to conveniently confirm the left-right air outlet direction of the air conditioning outlet 100, and improving the user experience.

The indication mark 220 includes a plurality of first marks 221 extending in the vehicle-width direction X, and an inclination direction of the first marks 221 extending in the vehicle-width direction X relative to the vehicle-height direction Y indicates an up-down air outlet direction of the air conditioning outlet 100. When the air direction of the air conditioning outlet 100 shifts downward, the first marks 221 located above and below the air conditioning outlet 100 will rotate correspondingly, and a left end of the first mark 221 located on the left side of the air conditioning outlet 100 will incline downward, a right end of the first mark 221 located on the right side of the air conditioning outlet 100 will incline downward. Accordingly, the user can confirm the up-down air outlet direction of the air conditioning outlet 100 according to the up-down inclination direction of the first mark 221, thereby allowing the user to conveniently confirm the up-down air outlet direction of the air conditioning outlet 100, and improving the user experience.

In addition, the length of the first mark 221 may change with the size of the air outlet volume of the air conditioning outlet 100, and the larger the air outlet volume of the air conditioning outlet 100, the longer the length of the first mark 221. Accordingly, the number of pieces of the air outlet state information acquired by the user at the same time can be increased, the number of times of head lowering during parameter viewing can be reduced, the driving safety can be improved, and the user experience can be improved.

Meanwhile, the color of the first mark 221 may change with the air outlet temperature of the air conditioning outlet 100, and when the air outlet temperature of the air conditioning outlet 100 is lower than the temperature in the compartment, the color of the first mark 221 is blue, and the lower the temperature, the darker the blue displayed by the first mark 221. When the air outlet temperature of the air conditioning outlet 100 is equal to or higher than the temperature in the compartment, the color of the first mark 221 is red, and the higher the temperature, the darker the red displayed by the first mark 221. Accordingly, the user can determine the air outlet temperature of the air conditioning outlet 100 by the color of the first mark 221, so that the air outlet temperature information of the air conditioning outlet 100 can be displayed to the user more intuitively, thereby allowing the user to conveniently confirm the air outlet temperature of the air conditioning outlet 100. Further, a type of the state information of the air conditioning outlet 100 included in the first mark 221 can be increased, the number of times of head lowering during parameter viewing can be reduced, the driving safety can be improved, and the user experience can be improved.

In the above embodiment, an example is described in which the air conditioning outlet is provided on the instrument panel, but this application is not limited thereto, for example, the present invention may also be applied to an air conditioning outlet structure provided at a panel front rail in front of a leg of a passenger, or an air conditioning outlet structure provided on inner walls of a vehicle cabin on left and right sides of the passenger. In this case, on an interior trim panel of the vehicle cabin, an indication mark used for indicating an air outlet direction is displayed at a position around an air conditioning outlet, thereby improving the user experience.

It should be noted that the above is only a preferred embodiment and technical principle applied of this application. Those having ordinary skills in the art will understand that the present invention is not limited to the specific embodiments described herein, and various obvious changes, readjustments and substitutions can be made by those having ordinary skills in the art without departing from the scope of the present invention. Therefore, although this application has been described in detail through the above embodiments, the present disclosure is not limited to the above embodiments, and other equivalent embodiments may also be included without departing from the concept of the present invention, all of which belong to the protection scope of the present invention.

What is claimed is:

1. An in-vehicle air conditioning outlet state indicator, comprising:
at least one air conditioning outlet of which an air outlet direction is changeable; and
an interior trim panel provided with an indication unit displaying, in a working state, an indication mark used for indicating a current air outlet direction of the air conditioning outlet, wherein
when the air outlet direction of the air conditioning outlet changes, the indication mark also changes,
or when the indication mark changes, the air outlet direction of the air conditioning outlet also changes.

2. The in-vehicle air conditioning outlet state indicator according to claim 1, wherein
the indication mark includes at least one first mark extending in a vehicle-height direction or a vehicle-width direction, and an inclination direction of the first mark relative to the vehicle-height direction or the vehicle-width direction indicates the air outlet direction of the air conditioning outlet.

3. The in-vehicle air conditioning outlet state indicator according to claim 2, wherein
the indication mark includes the at least one first mark extending in the vehicle-height direction, and an inclination direction of the first mark extending in the vehicle-height direction relative to the vehicle-width direction indicates a left-right air outlet direction of the air conditioning outlet.

4. The in-vehicle air conditioning outlet state indicator according to claim 2, wherein
the indication mark includes the at least one first mark extending in the vehicle-width direction, and an inclination direction of the first mark extending in the vehicle-width direction relative to the vehicle-height direction indicates an up-down air outlet direction of the air conditioning outlet.

5. The in-vehicle air conditioning outlet state indicator according to claim 3, wherein
the indication mark further includes a second mark arranged on the first mark, and a position where the second mark is present on the first mark in the vehicle-height direction is used to indicate an up-down air outlet direction of the air conditioning outlet.

6. The in-vehicle air conditioning outlet state indicator according to claim 2, wherein
a size of the first mark is used to indicate an air outlet volume of the air conditioning outlet.

7. The in-vehicle air conditioning outlet state indicator according to claim 6, wherein
the size of the first mark includes at least one of an area, a length, and a width of the first mark.

8. The in-vehicle air conditioning outlet state indicator according to claim 1, wherein
the indication mark includes at least one third mark with a gradually changing width, and a direction in which the width of the third mark gradually changes is used to indicate the air outlet direction of the air conditioning outlet.

9. The in-vehicle air conditioning outlet state indicator according to claim 8, wherein
the third mark gradually changes in width in a vehicle-height direction, and a direction in which the width of the third mark decreases or increases indicates an up-down air outlet direction of the air conditioning outlet.

10. The in-vehicle air conditioning outlet state indicator according to claim 9, wherein
an inclination direction of the third mark relative to a vehicle-width direction indicates a left-right air outlet direction of the air conditioning outlet.

11. The in-vehicle air conditioning outlet state indicator according to claim 8, wherein
the third mark gradually changes in width in a vehicle-width direction, and a direction in which the width of the third mark decreases or increases indicates a left-right air outlet direction of the air conditioning outlet.

12. The in-vehicle air conditioning outlet state indicator according to claim 11, wherein
an inclination direction of the third mark relative to a vehicle-height direction indicates an up-down air outlet direction of the air conditioning outlet.

13. The in-vehicle air conditioning outlet state indicator according to claim 1, wherein
the indication mark includes at least one fourth mark for flow display, swing display, or rotation display, and a direction of the flow display, the swing display, or the rotation display of the fourth mark is used to indicate the air outlet direction of the air conditioning outlet.

14. The in-vehicle air conditioning outlet state indicator according to claim 1, wherein
the indication mark includes at least two types of marks, and a combination of the at least two types of marks can be used to indicate at least a left-right air outlet direction and an up-down air outlet direction of the air conditioning outlet.

15. The in-vehicle air conditioning outlet state indicator according to claim 1, wherein
a color of the indication mark is used to indicate an air outlet temperature of the air conditioning outlet.

16. The in-vehicle air conditioning outlet state indicator according to claim 1, wherein
the indication mark is located at a position around the air conditioning outlet.

17. The in-vehicle air conditioning outlet state indicator according to claim 1, wherein
the air conditioning outlet is provided with a sensor for detecting at least one of the air outlet direction, an air outlet temperature, and an air outlet volume.

18. The in-vehicle air conditioning outlet state indicator according to claim 17, wherein
the indication unit is activated to enter the working state based on a detection result of the sensor.

19. The in-vehicle air conditioning outlet state indicator according to claim 1, wherein
the indication unit is activated to enter the working state when the air conditioning outlet is in an open state.

20. The in-vehicle air conditioning outlet state indicator according to claim 1, wherein
the indication unit includes a sleep state in which the indication mark is not displayed, and the indication unit enters the sleep state after maintaining the working state for a predetermined period of time.

21. The in-vehicle air conditioning outlet state indicator according to claim 20, wherein
the indication unit can be switched from the sleep state to the working state by any means of voice, button, touch, gesture, and sight.

22. The in-vehicle air conditioning outlet state indicator according to claim 1, wherein
the interior trim panel is provided with an ambient light, and the indication mark includes at least a part of the ambient light.

23. The in-vehicle air conditioning outlet state indicator according to claim 1, wherein
the interior trim panel is provided with an ambient light of which a display mode is linked with the indication mark.

24. The in-vehicle air conditioning outlet state indicator according to claim 1, wherein
the indication mark is a light-emitting pattern that changes statically or dynamically.

25. The in-vehicle air conditioning outlet state indicator according to claim 1, wherein
the air outlet direction of the air conditioning outlet at least includes a left-right air outlet direction and an up-down air outlet direction, and the indication mark is used to indicate at least one of the air outlet directions.

26. The in-vehicle air conditioning outlet state indicator according to claim 1, wherein
the indication mark is able to be set by user selection or a customized setting.

27. The in-vehicle air conditioning outlet state indicator according to claim 1, wherein
a change of the air outlet direction of the air conditioning outlet includes any of the following: a change of the air outlet direction of the air conditioning outlet caused by the user manually adjusting the air outlet direction of the air conditioning outlet; a change of the air outlet direction of the air conditioning outlet caused by an automatic adjustment of the air conditioning outlet; and an adjustment of the air outlet direction of the air conditioning outlet caused by the user adjusting a display state of the indication mark.

28. The in-vehicle air conditioning outlet state indicator according to claim 1, wherein
one indication unit is able to be used to indicate current air outlet directions of at least two air conditioning outlets.

29. A vehicle comprising: at least one seat; and the in-vehicle air conditioning outlet state indicator according to claim 1, wherein
the seat is provided corresponding to at least one air conditioning outlet and at least one indication unit.

30. The vehicle according to claim 29, wherein
the air conditioning outlet corresponding to the seat is in an open state, and when a user sits on the seat, the indication unit corresponding to the seat enters the working state.

31. The vehicle according to claim 29, wherein
the indication unit corresponding to the air conditioning outlet enters the working state when the indication unit is in a sleep state and a user adjusts a state of the air conditioning outlet, or the indication unit enters the working state when the indication unit is in the sleep state and approaching of a user is sensed.

32. The vehicle according to claim 29, wherein
the indication unit is located within an observable range of a user sitting on the seat when the user looks straight ahead.

33. The vehicle according to claim 29, wherein
the vehicle includes a driver seat, a passenger seat, and a rear seat, and the indication unit corresponding to the driver seat is located on an instrument panel on a side of the vehicle close to the driver seat, or, the indication unit corresponding to the passenger seat is located on an instrument panel on a side of the vehicle close to the passenger seat or located at an inner side of a vehicle door on the side of the passenger seat, or, the indication unit corresponding to the rear seat is located at a back portion of the driver seat or the passenger seat, or located at an inner side of a vehicle door closest to the rear seat or at a rear end of a front central console armrest.

34. The vehicle according to claim 29, wherein
the vehicle includes a plurality of interior trim panels corresponding to a plurality of the seats, and a plurality of the indication units corresponding to the plurality of the seats in the vehicle are arranged on the same interior trim panel, or the plurality of the indication units corresponding to the plurality of the seats in the vehicle are respectively arranged on different interior trim panels, or at least two indication units among the plurality of the indication units corresponding to the plurality of the seats in the vehicle are arranged on the same interior trim panel.

35. The vehicle according to claim 29, wherein
the vehicle includes a plurality of the interior trim panels corresponding to the plurality of the seats, and a user is able to set at least one of the indication units to any of the plurality of the interior trim panels by himself/herself.
